(19) United States
(12) Patent Application Publication
(10) Pub. No.: US 2021/0144418 A1
(43) Pub. Date: May 13, 2021

(54) PROVIDING VIDEO RECOMMENDATION

(71) Applicant: Microsoft Technology Licensing, LLC, Redmond, WA (US)

(72) Inventors: Bo HAN, Redmond, WA (US); Qiao LUAN, Redmond, WA (US); Yang WANG, Redmond, WA (US); Albert THAMBIRATNAM, Redmond, WA (US)

(21) Appl. No.: 17/256,951

(22) PCT Filed: Aug. 10, 2018
(86) PCT No.: PCT/CN2018/099914

§ 371 Date: Dec. 29, 2020

(51) Int. Cl. H04N 21/234; G06K 9/00; G06K 9/62; H04N 21/25; H04N 21/258

(52) U.S. Cl. CPC H04N 21/23418; G06K 9/00744; H04N 21/25891; H04N 21/251; H04N 21/25825; G06K 9/6256

(57) ABSTRACT

The present disclosure provides method and apparatus for providing video recommendation. At least one reference factor for the video recommendation may be determined, wherein the at least one reference factor indicates preferred importance of visual information and/or audio information in at least one video to be recommended. A ranking score of each candidate video in a candidate video set may be determined based at least on the at least one reference factor. At least one recommended video may be selected from the candidate video set based at least on ranking scores of candidate videos in the candidate video set. The at least one recommended video may be provided to a user through a terminal device.

### BACKGROUND

The developments of the network and various digital devices have enabled people to watch videos they like at any time. Due to the convenience of creating, editing and sharing videos, the number of videos available on the network is enormous and grows every day. This makes it more and more difficult to find contents in which users are most interested. Due to limited time that the users have, effective video recommendation to the users becomes more and more important.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure propose method and apparatus for providing video recommendation. At least one reference factor for the video recommendation may be determined, wherein the at least one reference factor indicates preferred importance of visual information and/or audio information in at least one video to be recommended. A ranking score of each candidate video in a candidate video set may be determined based at least on the at least one reference factor. At least one recommended video may be selected from the candidate video set based at least on ranking scores of candidate videos in the candidate video set. The at least one recommended video may be provided to a user through a terminal device.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates exemplary implementation scenarios of providing video recommendation according to an embodiment.

FIG. 2 illustrates an exemplary process for determining content scores of candidate videos according to an embodiment.

FIG. 3 illustrates an exemplary process for determining recommended videos according to an embodiment.

FIG. 4 illustrates an exemplary process for determining recommended videos according to an embodiment.

FIG. 5 illustrates an exemplary process for determining recommended videos according to an embodiment.

FIG. 6 illustrates an exemplary process for determining recommended videos according to an embodiment.

FIG. 7 illustrates an exemplary process for determining recommended videos according to an embodiment.

FIG. 8 illustrates a flowchart of an exemplary method for providing video recommendation according to an embodiment.

FIG. 9 illustrates an exemplary apparatus for providing video recommendation according to an embodiment.

FIG. 10 illustrates an exemplary apparatus for providing video recommendation according to an embodiment.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

Applications or websites being capable of accessing various video resources on the network may provide video recommendation to users. The applications or websites may be news clients or websites, social networking applications or websites, video platforms clients or websites, search engine clients or websites, etc., such as, CNN News, Toutiao, Facebook, Youtube, Youku, Bing, Baidu, etc. The applications or websites may select a plurality of videos from the video resources on the network as recommended videos and provide the recommended videos to users for consumption. When determining whether a video on the network should be selected as a recommended video, those existing approaches for determining recommended videos from the video resources on the network may consider some factors, e.g., freshness of the video, popularity of the video, click rate of the video, video quality, relevance between content of the video and a user's interests, etc. For example, if the video quality indicates that the video comes from an entity having a high authority and/or the video has a high definition, this video is more likely to be selected as a recommended video. For example, if the content of the video belongs to a category of football and the user always shows interest in football-related videos, i.e., there is a high relevance between the content of the video and the user's interests, this video may be recommended to the user with a high probability.

It is known that a video may comprise visual information and audio information, wherein the visual information indicates a series of pictures being visually presented in the video, and the audio information indicates voice, sound, music, etc. being presented in an audio form in the video. In some cases, when a user is consuming a recommended video on a terminal device, it may be inconvenient for the user to consume both visual information and audio information of the recommended video. For example, the user may be preparing dinner in a kitchen, and thus the user can keep listening but cannot keep watching a screen of the terminal device. For example, if it is eight o′clock in the morning and the user is on the subway now, the user may prefer to consume visual information of a recommended video but doesn't want any sounds to be displayed to disturb others. For example, assuming that the terminal device is a smart phone and the smart phone is operating in a mute mode, and thus the user can not consume audio information in the recommended video. For example, assuming that the terminal device is a smart speaker with a small screen or with no screen, and the user is driving a car now, and thus it may be not suitable for the user to consume visual information in the recommended video.

Embodiments of the present disclosure propose to improve video recommendation through considering importance of visual information and/or audio information in recommended videos during determining the recommended videos. Herein, importance of visual information and/or audio information in a video may indicate, e.g., whether content of the video is conveyed mainly by the visual information and/or the audio information, whether the visual information or the audio information is the most critical information in the video, whether the visual information and/or the audio information is indispensable or necessary for consuming the video, etc. Importance of visual information and importance of audio information may vary for different videos. For example, for a speech video, importance of audio information is higher than importance of visual information because the video presents content of the speech mainly in an audio form. For example, for a video recording a cute dog's activities, audio information may be less important than visual information because the video may present the activities of the dog mainly in a visual form. For example, for a dancing video, both visual information and audio information may be important because the video may present dance movements in a visual form and meanwhile present music in an audio form. It can be seen that, when a user is consuming a video, either visual information or audio information that has a higher importance may be sufficient for the user to acknowledge or understand content of the video.

When determining recommended videos from a plurality of candidate videos, the embodiments of the present disclosure may decide whether to recommend those videos having a higher importance of visual information, or to recommend those videos having a higher importance of audio information, or to recommend those videos having both a high importance of visual information and a high importance of audio information, and accordingly select corresponding candidate videos as the recommended videos. Through considering importance of visual information and/or audio information in candidate videos during determining videos to be recommended, the embodiments of the present disclosure may improve a ratio of satisfactorily consumed videos in the video recommendation.

FIG. 1 illustrates exemplary implementation scenarios of providing video recommendation according to an embodiment. Exemplary network architecture 100 is shown in FIG. 1, and the video recommendation may be provided in the network architecture 100.

In the network architecture 100, a network 110 is applied for interconnecting various network entities. The network 110 may be any type of networks capable of interconnecting network entities. The network 110 may be a single network or a combination of various networks. In terms of coverage range, the network 110 may be a Local Area Network (LAN), a Wide Area Network (WAN), etc. In terms of carrying medium, the network 110 may be a wireline network, a wireless network, etc. In terms of data switching techniques, the network 110 may be a circuit switching network, a packet switching network, etc.

As shown in FIG. 1, a video recommendation server 120, service providing websites 130, video hosting servers 140, video resources 142, terminal devices 150 and 160, etc. may connect to the network 110.

The video recommendation server 120 may be configured for providing video recommendation according to the embodiments of the present disclosure, e.g., determining recommended videos and providing the recommended videos to users. In this disclosure, providing recommended videos may refer to providing links of the recommended videos, providing graphical indications containing links of the recommended videos, displaying at least one of the recommended videos directly, etc.

The service providing websites 130 exemplarily represent various websites that may provide various services to users, wherein the provided services may comprise video-related services. For example, the service providing websites 130 may comprise, e.g., a news website, a social networking website, a video platform website, a search engine website, etc. Moreover, the service providing websites 130 may also comprise a website established by the video recommendation server 120. When the users is accessing the service providing websites 130, the service providing websites 130 may be configured for interacting with the video recommendation server 120, obtaining recommended videos from the video recommendation server 120, and providing the recommended videos to the users. Thus, the video recommendation server 120 may provide video recommendation in the services provided by the service providing websites 130. It should be appreciated that although the video recommendation server 120 is exemplarily shown as separated from the service providing websites 130 in FIG. 1, functionality of the video recommendation server 120 may also be implemented or incorporated in the service providing websites 130.

The video hosting servers 140 exemplarily represent various network entities capable of managing videos, which support uploading, storing, displaying, downloading, or sharing of videos. The videos managed by the video hosting servers 140 are collectively shown as the video resources 142. The video resources 142 may be stored or maintained in various databases, cloud storages, etc. The video resources 142 may be accessed or processed by the video hosting servers 140. It should be appreciated that although the video resources 142 is exemplarily shown as separated from the video hosting servers 140 in FIG. 1, the video resources 142 may also be incorporated in the video hosting servers 140. Moreover, although not shown, functionality of the video hosting servers 140 may also be implemented or incorporated in the service providing websites 130 or the video recommendation server 120. Furthermore, a part of or all of the video resources 142 may also be possessed, accessed, stored or managed by the service providing websites 130 or the video recommendation server 120.

When providing video recommendation, the video recommendation server 120 may access the video resources 142 and determine the recommended videos from the video resources 142.

The terminal devices 150 and 160 in FIG. 1 may be any type of electronic computing devices capable of connecting to the network 110, accessing servers or websites on the network 110, processing data or signals, presenting multimedia contents, etc. For example, the terminal devices 150 and 160 may be smart phones, desktop computers, laptops, tablets, AI terminals, wearable devices, smart TVs, smart speakers, etc. Although two terminal devices are shown in FIG. 1, it should be appreciated that a different number of terminal devices may connect to the network 110. The terminal devices 150 and 160 may be used by users for obtaining various services provided through the network 110, wherein the services may comprise video recommendation.

As an example, a client application 152 is installed in the terminal device 150, wherein the client application 152 represents various applications or clients that may provide services to a user of the terminal device 150. For example, the client application 152 may be, a news client, a social networking application, a video platform client, a search engine client, etc. Moreover, the client application 152 may also be a client associated with the video recommendation server 120. The client application 152 may communicate with a corresponding application server to provide services to the user. In a circumstance, when the user of the terminal device 150 is accessing the client application 152, the client application 152 may interact with the video recommendation server 120, obtain recommended videos from the video recommendation server 120, and provide the recommended videos to the users within the service provided by the client application 152. In a circumstance, if the functionality of the video recommendation server 120 is implemented or incorporated in the application server corresponding to the client application 152, the client application 152 may receive recommended videos from the corresponding application server, and provide the recommended videos to the users.

As an example, although the terminal device 160 is not shown as having installed any client application, a user of the terminal device 160 may still obtain various services through accessing websites, e.g., the service providing websites 130, on the network 110. During the user is accessing the service providing websites 130, the video recommendation server 120 may determine recommended videos, and the recommended videos may be provided to the user within the services provided by the service providing websites 130.

It should be appreciated that, in any of the above circumstances, if the user of the terminal device 150 or 160 makes a user input in the client application 152 or on the service providing websites 130, this user input may also be provided to and considered by the video recommendation server 120 so as to provide recommended videos.

In the case that the user of the terminal device 150 obtains recommended videos through the client application 152, when the user wants to consume a recommended video, e.g., clicks a link or a graphical indication of the recommended video in the client application 152, the client application 152 may communicate with the video hosting servers 140 to obtain a corresponding video file and then display the video to the user. In the case that the user of the terminal device 160 obtains recommended videos on a web page provided by the service providing websites 130, when the user wants to consume a recommended video, e.g., clicks a link or a graphical indication of the recommended video on the web page provided by the service providing websites 130, the terminal device 160 may communicate with the video hosting servers 140 to obtain a corresponding video file and then display the video to the user. In other cases, when the recommended videos are provided to the user either in the client application 152 or on the web page provided by the service providing websites 130, any of the recommended videos may also be displayed to the user directly.

Moreover, it should be appreciated that all the entities or units shown in FIG. 1 and all the implementation scenarios discussed above are exemplary, and depending on specific requirements, any other entities or units may be involved in the network architecture 100 and any other implementation scenarios may be covered by the present disclosure.

According to some embodiments of the present disclosure, importance of visual information and/or audio information in each candidate video in a plurality of candidate videos may be determined in advance, wherein recommended videos are to be selected from the plurality of candidate videos. When determining the recommended videos from the plurality of candidate videos, the embodiments of the present disclosure may select candidate videos as the recommended videos based at least on importance of visual information and/or audio information in each candidate video.

FIG. 2 illustrates an exemplary process 200 for determining content scores of candidate videos according to an embodiment. Herein, a content score of a video is used for indicating importance of visual information and/or audio information in the video.

Video resources 210 on the network may provide a number of various videos, from which recommended videos may be selected and provided to users. The video resources 210 in FIG. 2 may correspond to the video resources 142 in FIG. 1.

Videos provided by the video resources 210 may form a candidate video set 220. The candidate video set 220 comprises a number of videos acting as candidates of recommended videos.

According to the embodiment of the present disclosure, a content score of each candidate video in the candidate video set 220 may be determined.

In an implementation, a content score of a candidate video may comprise two separate sub scores or a vector formed by the two separate sub scores, one sub score indicating importance of visual information in the candidate video, another sub score indicating importance of audio information in the candidate video. As an example, assuming that a content score of a candidate video is denoted as [0.8, 0.3], the first sub score “0.8” may indicate importance of visual information in the candidate video, and the second sub score “0.3” may indicate importance of audio information in the candidate video. Furthermore, assuming that sub scores range from 0 to 1, and a higher sub score indicates higher importance. Thus, in the previous example, the visual information would be of high importance for the candidate video, since the first sub score “0.8” is very close to the maximum score “1”, while the audio information would be of low importance for the candidate video, since the second sub score “0.3” is close to the minimum score “0”. That is, for this candidate video, the visual information is much more important than the audio information, and accordingly content of this candidate video may be conveyed mainly by the visual information. As another example, assuming that a content score of a candidate video is denoted as [0.8, 0.7], the first sub score “0.8” may indicate importance of visual information in the candidate video, and the second sub score “0.7” may indicate importance of audio information in the candidate video. Since both the first sub score “0.8” and the second sub score “0.7” are close to the maximum score “1”, both the visual information and the audio information in the candidate video have high importance. That is, content of this candidate video should be conveyed by both the visual information and the audio information.

In an implementation, a content score of a candidate video may comprise a single score, which may indicate a relative importance degree between visual information and audio information in the candidate video. Assuming that this signal score ranges from 0 to 1, and the higher the score is, the higher importance the visual information has and the lower importance the audio information has, while the lower the score is, the higher importance the audio information has and the lower importance the visual information has, or vice versa. As an example, assuming that a content score of a candidate video is “0.9”, since this score is much close to the maximum score “1”, it indicates that visual information in this candidate video is much more important than the audio information in this candidate video. As an example, assuming that a content score of a candidate video is “0.3”, since this score is much close to the minimum score “0”, it indicates that audio information in this candidate video is more important than the visual information in this candidate video. As an example, assuming that a content score of a candidate video is “0.6”, since this score is only a bit higher than a median score “0.5”, it indicates that both visual information and audio information in this candidate video are important except that the visual information is a little bit more important than the audio information.

It should be appreciated that all the above content scores, sub scores, score ranges, etc. are exemplary, and according to the embodiments of the present disclosure, the content score may be denoted in any other numeral, character, or code forms and may be defined with any other score ranges.

According to the embodiment of the present disclosure, a content score of a candidate video may be determined based on, e.g., at least one of shot transition, camera motion, scene, human, human motion, object, object motion, text information, audio attribute, and video metadata of the candidate video.

The “shot transition” refers to how many times shot transition occurs in a predetermined time period or in time duration of the candidate video. Taking a speech video as an example, a camera may focus on a lecturer at most time and the shots of audience may be very few, and thus shot transition of this video would be very few. Taking a travel video as example, various sceneries may be recorded in the video, e.g., a long shot of a mountain, a close shot of a river, people's activities on the grass, etc., and thus there may be many shot transitions in this video. Usually, more shot transitions may indicate more visual information existing in a candidate video. The shot transition may be detected among adjacent frames in the candidate video through any existing techniques.

The “camera motion” refers to movements of a camera in the candidate video. The camera motion may be characterized by, e.g., time duration, distance, number, etc. of the movements of the camera. Taking a speech video as an example, when the camera captures a lecturer in the middle of the screen, the camera may keep static for a long time so as to fix the picture of the lecturer in the middle of the screen, and during this time period, no camera motion occurs. Taking a video recording a running dog as an example, the camera may move along with the dog, and thus camera motion of this video, e.g., time duration, distance or number of movements of the camera, would be very high. Usually, a higher camera motion may indicate more visual information existing in a candidate video. The camera motion may be detected among adjacent frames in the candidate video through any existing techniques.

The “scene” refers to places or locations at where an event is happening in the candidate video. The scene may be characterized by, e.g., how many scenes occur in the candidate video. For example, if a video records an indoor picture, a car picture, and a football field picture sequentially, since each of the “indoor picture”, “car picture”, and “football field picture” is a scene, this video may be determined as including three scenes. Usually, more scenes may indicate more visual information existing in a candidate video. The scenes in the candidate video may be detected through various existing techniques. For example, the scenes in the candidate video may be detected through deep learning models for image categorization. Moreover, the scenes in the candidate video may also be detected through performing semantic analysis on text information derived from the candidate video.

The “human” refers to persons, characters, etc. appearing in the candidate video. The human may be characterized by, e.g., how many human beings appear in the candidate video, whether a special human beings is appearing in the candidate video, etc. Usually, more human beings may indicate more visual information existing in a candidate video. Moreover, if the human beings appeared in the candidate video are famous celebrities, e.g., movie stars, pop stars, sport stars, etc., this may indicate more visual information existing in the candidate video. The human beings in the candidate video may be detected through various existing techniques, e.g., deep learning models for face detection, face recognition, etc.

The “human motion” refers to movements, actions, etc. of human beings in the candidate video. The human motion may be characterized by, e.g., number, time duration, type, etc. of human motions appearing in the candidate video. Usually, more human motions and long-time human motions may indicate more visual information existing in a candidate video. Moreover, some types of human motions, e.g., shooting in a football game, may also indicate more visual information existing in a candidate video. The human motion may be detected among adjacent frames in the candidate video through any existing techniques.

The “object” refers to animals, articles, etc. appearing in the candidate video. The object may be characterized by, e.g., how many objects appear in the candidate video, whether special objects are appearing in the candidate video. Usually, more objects may indicate more visual information existing in a candidate video. Moreover, some special objects, e.g., a tiger, a turtle, etc., may also indicate more visual information existing in a candidate video. The objects in the candidate video may be detected through various existing techniques, e.g., deep learning models for image detection, etc.

The “object motion” refers to movements, actions, etc. of objects in the candidate video. The object motion may be characterized by, e.g., number, time duration, area, etc. of object motions appearing in the candidate video. Usually, more object motions and long-time object motions may indicate more visual information existing in a candidate video. Moreover, certain areas of object motions may also indicate more visual information existing in a candidate video. The object motion may be detected among adjacent frames in the candidate video through any existing techniques.

The “text information” refers to informative texts in the candidate video, e.g., subtitles, closed captions, embedded text, etc. The text information may be characterized by, e.g., the amount of informative texts. Taking a video of talk show as an example, all the sentences spoken by attendees may be shown in a text form on the picture of the video, and thus this video may be determined as having a large amount of text information. Taking a cooking video as an example, during a cooker is explaining how to cook a dish in the video, steps of cooking the dish may be shown in a text form on the picture of the video synchronously, and thus this video may be determined as having a large amount of text information. Since text information is usually generated based at least on content in a candidate video and a user may understand content in the candidate video through the text information instead of corresponding audio information, more text information may indicate lower importance of audio information in the candidate video. Text information in the candidate video may be detected through various existing techniques. For example, subtitles and closed captions may be detected through decoding a corresponding text file of the candidate video, and embedded text, which has been merged with the picture of the candidate video, may be detected through, e.g., Optical Character Recognition (OCR), etc.

The “audio attribute” refers to categories of audio appearing in the candidate video, e.g., voice, sing, music, etc. Various audio attributes may indicate different importance of audio information in the candidate video. For example, in a video recording a girl who is singing, the audio information, i.e., singing by the girl, may indicate a high importance of audio information. The audio attribute of the candidate video may be detected based on, e.g., audio tracks in the candidate video through any existing techniques.

The “video metadata” refers to descriptive information associated with the candidate video obtained from a video resource, comprising, e.g., video category, title, etc. The video category may be, e.g., “funny”, “education”, “talk show”, “game”, “music”, “news”, etc., which may facilitate to determine importance of visual information and/or audio information. Taking a game video as an example, it is likely that visual information in the video is more important than audio information in the video. Taking a video of talk show as example, it is likely that audio information in the video has a high importance. The title of the candidate video may comprise some keywords, e.g., “song”, “interview”, “speech”, etc., which may facilitate to determine importance of visual information and/or audio information. For example, if the title of the candidate video is “Election Speech”, it is very likely that audio information in the candidate video is more important than visual information in the candidate video.

It should be appreciated that any two or more of the above discussed shot transition, camera motion, scene, human, human motion, object, object motion, text information, audio attribute, and video metadata may be combined together so as to determine the content score of the candidate video. For example, for a video recording a cute dog's activities, this video may contain a large amount of camera motions and object motions but does not include any speech or music, and thus a content score indicating a high importance of visual information may be determined for this video. For example, for a speech video, this video may contain a long time-duration speech, few shot transition, few camera motions, few scenes, a title including a keyword “speech”, etc., and thus a content score indicating a high importance of audio information may be determined for this video.

In an implementation, a content side model may be adopted for determining the content score of the candidate video as discussed above. For example, as shown in FIG. 2, a content side model 230 is used for determining a content score of each candidate video in the candidate video set 220. The content side model 230 may be established based on various techniques, e.g., machine learning, deep learning, etc. Features adopted by the content side model 230 may comprise at least one of: shot transition, camera motion, scene, human, human motion, object, object motion, text information, audio attribute, and video metadata, as discussed above. In terms of function, the content side model 230 may be, e.g., a regression model, a classification model, etc. In terms of structure, the content side model may be based on, e.g., a linear model, a logistic model, a decision tree model, a neural network model, etc. Training data for the content side model 230 may be obtained through: obtaining a group of videos to be used for training; for each video in the group of videos, labeling respective values corresponding to the features of the content side model, and labeling a content score for the video; and forming training data from the group of videos with respective labels.

In FIG. 2, through the content side model 230, a content score of each candidate video in the candidate video set 220 may be determined, and accordingly the candidate video set with respective content scores 240 may be finally obtained, which may be further used for determining recommended videos.

In the above discussion, the content side model 230 is implemented as a model which adopts features comprising at least one of: shot transition, camera motion, scene, human, human motion, object, object motion, text information, audio attribute, and video metadata. However, it should be appreciated that the content side model 230 may also be implemented in any other approaches. For example, the content side model 230 may be a deep learning-based model, which can determine or predict a content score of each candidate video directly based on visual and/or audio stream of the candidate video without extracting any heuristically designed features. This content side model may be trained by a set of training data. Each training data may be formed by a video and a labeled content score indicating importance of visual information and/or audio information in the video.

According to the embodiments of the present disclosure, at least one reference factor may be used for the video recommendation. Herein, a reference factor may indicate preferred importance of visual information and/or audio information in at least one video to be recommended. That is, the at least one reference factor may provide references or criteria for determining recommended videos. For example, the at least one reference factor may indicate whether to recommend those videos having a higher importance of visual information, or to recommend those videos having a higher importance of audio information, or to recommend those videos having both a high importance of visual information and a high importance of audio information. The at least one reference factor may comprise an indication of a default or current service configuration of the video recommendation, a preference score of the user, a user input from the user, etc., which will be discussed in details later.

FIG. 3 illustrates an exemplary process 300 for determining recommended videos according to an embodiment. In the process 300, an indication of service configuration of the video recommendation is used as a reference factor for determining recommended videos.

According to the process 300, service configuration 310 of the video recommendation may be obtained. The service configuration 310 refers to configuration about how to provide recommended videos to a user which is set in a client application or service providing website. The service configuration 310 may be a default service configuration of the video recommendation, or a current service configuration of the video recommendation. In an implementation, the service configuration 310 may comprise providing recommended videos in a mute mode, or providing recommended videos in a non-mute mode. For example, as for the case of providing recommended videos in a mute mode, those videos with high importance of visual information are suitable to be recommended, whereas those videos with high importance of audio information are not suitable to be recommended since the audio information cannot be displayed to the user.

According to the process 300, a ranking score of a candidate video may be determined based at least on a content score of the candidate video and an indication of the service configuration 310. In an implementation, the indication of the service configuration 310 may be provided to a ranking model 320 as a reference factor. Moreover, a candidate video set with content scores 330 may also be provided to the ranking model 320, wherein the candidate video set with content scores 330 corresponds to the candidate video set with content scores 240 in FIG. 2. The ranking model 320 may be an improved version of any existing ranking models for video recommendation. The existing ranking models may determine a ranking score of each candidate video based on features of freshness of the video, popularity of the video, click rate of the video, video quality, relevance between content of the video and the user's interests, etc. Besides the features adopted in the existing ranking models, the ranking model 320 may further adopt a content score of a candidate video and at least one reference factor, i.e., the indication of the service configuration 310 in FIG. 3, as additional features. That is, the ranking model 320 may determine a ranking score of each candidate video in the candidate video set based at least on a content score of the candidate video and the indication of the service configuration 310. Through considering the indication of the service configuration 310, the ranking model 320 may acknowledge what types of candidate videos, e.g., whether visual information is important or audio information is important, should be given a higher ranking in the following selection of recommended videos. Through considering the content score of the candidate video, the ranking model 320 may decide whether this candidate video complies with the reference or criteria acknowledged before. Thus, the ranking model 320 may determine a ranking score of a candidate video in a consideration of importance of visual information and/or audio information, e.g., give a higher ranking score to a candidate video which has a content score complying with the indication of the service configuration 310. Through the ranking model 320, the candidate video set with respective ranking scores 340 may be obtained.

The ranking model 320 may be established based on various techniques, e.g., machine learning, deep learning, etc. Features adopted by the ranking model 320 may comprise a content score of a candidate video, indication of a service configuration, together with any features adopted by the existing ranking models. In terms of structure, the ranking model 320 may be based on, e.g., a linear model, a logistic model, a decision tree model, a neural network model, etc.

According to the process 300, after the candidate video set with respective ranking scores 340 is obtained, recommended videos 350 may be selected from the candidate video set based at least on ranking scores of candidate videos in the candidate video set. For example, a plurality of highest ranked candidate videos may be selected as recommended videos.

The recommended videos 350 may be further provided to the user through a terminal device of the user.

FIG. 4 illustrates an exemplary process 400 for determining recommended videos according to an embodiment. In the process 400, a preference score of the user is used as a reference factor for determining recommended videos.

According to the process 400, a preference score 410 of the user may be obtained. The preference score may indicate expectation degree of the user for visual information and/or audio information in a video to be recommended. That is, the preference score may indicate whether the user expects to obtain recommended videos with high importance of visual information or expects to obtain recommended videos with high importance of audio information. Assuming that the preference score ranges from 0 to 1, and the higher the score is, the higher importance of visual information the user expects, while the lower the score is, the higher importance of audio information the user expects. As an example, assuming that a preference score of the user is “0.9”, since this score is much close to the maximum value “1”, it indicates that the user is very expecting to obtain recommended videos with high importance of visual information. The preference score may be determined based on at least one of: current time, current location, configuration of the terminal device of the user, operating state of the terminal device, and historical watching behaviors of the user.

The “current time” refers to the current time point, time period of a day, date, day of the week, etc. when the user is accessing the client application or service providing website in which video recommendation is provided. Different “current time” may reflect different expectations of the user. For example, if it is 11 PM now, the user may desire recommended videos with low importance of audio information so as to avoid disturbing other sleeping people.

The “current location” refers to where the user is located now, e.g., home, office, subway, street, etc. The current location of the user may be detected through various existing approaches, e.g., through GPS signals of the terminal device, through locating a WiFi device with which the terminal device is connecting, etc. Different “current location” may reflect different expectations of the user. For example, if the user is at home now, the user may desire recommended videos with both high importance of visual information and high importance of audio information, while if the user is at office now, the user may not desire recommend videos with high importance of audio information because it is inconvenient to hear audio information at office.

The “configuration of the terminal device” may comprise at least one of: screen size, screen resolution, loudspeaker available or not, and peripheral earphone connected or not, etc. The configuration of the terminal device may restrict the user's consumption of recommended videos. For example, if the terminal device only has a small screen size or a low screen resolution, it is not suitable to recommend videos with high importance of visual information. For example, if the loudspeaker of the terminal device is off now, it is not suitable to recommend videos with high importance of audio information.

The “operating state of the terminal device” may comprise at least one of operating in a mute mode, operating in a non-mute mode, operating in a driving mode, etc. For example, if the terminal device is in a mute mode, the user may desire recommended videos with high importance of visual information instead of recommended videos with high importance of audio information. If the terminal device is in a driving mode, e.g., the user of the terminal device is driving a car, the user may desire recommended videos with high importance of audio information.

The “historical watching behaviors of the user” refers to the user's historical watching actions of previous recommended videos. For example, if the user has watched five recently-recommended videos with high importance of visual information, it is very likely that the user may desire to obtain more recommended videos with high importance of visual information. For example, if during the recent week, the user has watched most of recommended videos with high importance of audio information, it may indicate that the user may expect to obtain more recommended videos with high importance of audio information.

It should be appreciated that any two or more of the above discussed current time, current location, configuration of the terminal device, operating state of the terminal device, and historical watching behaviors of the user may be combined together so as to determine the preference score of the user. For example, if the current location is the office, and the operating state of the terminal device is in a mute mode, then a preference score indicating a high expectation degree of the user for visual information in a video to be recommended may be determined. For example, if the current time is 11PM, and the historical watching behaviors of the user shows that the user has not watched the previously-recommended several videos with high importance of audio information at 11 PM, then a preference score indicating a high expectation degree of the user for visual information in a video to be recommended may be determined. In one case, the preference score may be determined only based on user state-related information, e.g., at least one of the current time, the current location, historical watching behaviors of the user, etc. In one case, the preference score may be determined only based on terminal device-related information, e.g., at least one of configuration of the terminal device, operating state of the terminal device, etc. In one case, the preference score may also be determined based on both the user state-related information and the terminal device-related information.

In an implementation, a user side model may be adopted for determining the preference score of the user as discussed above. For example, as shown in FIG. 4, a user side model 420 is used for determining the preference score 410. The user side model 420 may be established based on various techniques, e.g., machine learning, deep learning, etc. Features adopted by the user side model 420 may comprise at least one of: time, location, configuration of the terminal device, operating state of the terminal device, and historical watching behaviors of the user, as discussed above. In terms of function, the user side model 420 may be, e.g., a regression model, a classification model, etc. In terms of structure, the user side model 420 may be based on, e.g., a linear model, a logistic model, a decision tree model, a neural network model, etc. Training data for the user side model 420 may be obtained from historical watching records of the user, wherein each historical watching record is associated with a watching action of a historical recommended video by the user. Information corresponding to the features of the user side model may be obtained from a historical watching record, and a preference score may also be labeled for this historical watching record. The obtained information and the labeled preference score together may be used as a piece of training data. In this way, a set of training data may be formed based on a number of historical watching records of the user.

It should be appreciated that it is possible that the user possesses more than one terminal device and the user may use any of these terminal devices to access the client application or service providing website. In this case, a user side model may be established for each terminal device. For example, assuming that the user has two terminal devices, a first user side model may be established based on user state-related information and the first terminal device-related information, and a second user side model may be established based on user state-related information and the second terminal device-related information. Thus, the preference score of the user may be determined through a user side model corresponding to the terminal device currently-used by the user.

According to the process 400, a ranking score of a candidate video may be determined based at least on a content score of the candidate video and the preference score 410. In an implementation, the preference score 410 of the user may be provided to a ranking model 430 as a reference factor. Moreover, a candidate video set with content scores 440 may also be provided to the ranking model 430, wherein the candidate video set with content scores 440 corresponds to the candidate video set with content scores 240 in FIG. 2. The ranking model 430 is similar with the ranking model 320, except that the reference factor in FIG. 4 is the preference score 410 instead of the service configuration 310. Besides the features adopted in the existing ranking models, the ranking model 430 may further adopt a content score of a candidate video and at least one reference factor, i.e., the preference score 410 in FIG. 4, as additional features. That is, the ranking model 430 may determine a ranking score of each candidate video in the candidate video set based at least on a content score of the candidate video and the preference score 410. Through considering the preference score 410, the ranking model 430 may acknowledge what types of candidate videos, e.g., whether visual information is important or audio information is important, are expected by the user. Through considering the content score of the candidate video, the ranking model 430 may decide whether this candidate video complies with the expectation of the user. Thus, the ranking model 430 may determine a ranking score of a candidate video in a consideration of importance of visual information and/or audio information, e.g., give a higher ranking score to a candidate video which has a content score complying with the preference score 410. Through the ranking model 430, the candidate video set with respective ranking scores 450 may be obtained.

According to the process 400, after the candidate video set with respective ranking scores 450 is obtained, recommended videos 460 may be selected from the candidate video set based at least on ranking scores of candidate videos in the candidate video set. Moreover, the recommended videos 460 may be further provided to the user through the terminal device of the user.

It should be appreciated that although it is discussed above that the preference score may be determined based on at least one of: current time, current location, configuration of the terminal device, operating state of the terminal device, and historical watching behaviors of the user, the preference score may also be determined in consideration any other factors that may be used for indicating expectation degree of the user for visual information and/or audio information in a video to be recommended. In an implementation, the preference score may be determined further based on the user's schedule, wherein events in the schedule may indicate whether the user desires recommended videos with high importance of visual information or with high importance of audio information. For example, if the user's schedule shows that the user is at a meeting or having lessons at a classroom, then a preference score indicating a high expectation degree of the user for visual information in a video to be recommended may be determined. In an implementation, the preference score may be determined further based on the user's physical condition, wherein the physical condition may indicate whether the user desires recommended videos with high importance of visual information or with high importance of audio information. For example, if the user is having an eye disease, then a preference score indicating a high expectation degree of the user for audio information in a video to be recommended may be determined.

FIG. 5 illustrates an exemplary process 500 for determining recommended videos according to an embodiment. In the process 500, a user input from the user is used as a reference factor for determining recommended videos.

According to the process 500, a user input 510 may be obtained from the user. The user input may indicate expectation degree of the user for visual information and/or audio information in at least one video to be recommended. That is, the user input may indicate whether the user expects to obtain recommended videos with high importance of visual information or expects to obtain recommended videos with high importance of audio information.

In an implementation, the user input 510 may comprise a designation of preferred importance of visual information and/or audio information in at least one video to be recommended. For example, options of preferred importance may be provided in a user interface of the client application or service providing website, and the user may select one of the options in the user interface so as to designate preferred importance of visual information and/or audio information in at least one video to be recommended. The designation of preferred importance by the user may indicate that whether the user expects to obtain recommended videos with high importance of audio information, and/or to obtain recommended videos with high importance of visual information.

In an implementation, the user input 510 may comprise a designation of category of at least one video to be recommended. For example, the user may designate, in a user interface of the client application or service providing website, at least one desired category of the at least one video to be recommended. The designated category may be, e.g., “funny”, “education”, “talk show”, “game”, “music”, “news”, etc., which may indicate whether the user expects to obtain recommended videos with high importance of audio information, and/or to obtain recommended videos with high importance of visual information. For example, if a category “talk show” is designated by the user, it may indicate that the user expects to obtain recommended videos with high importance of audio information. For example, if a category “game” is designated by the user, it may indicate that the user expects to obtain recommended videos with high importance of visual information.

In an implementation, the user input 510 may comprise a query for searching videos. For example, when the user is accessing the client application or service providing website, the user may input a query in a user interface of the client application or service providing website so as to search one or more videos that the user is interested. For example, an exemplary query may be “American presidential election speech” which indicates that the user wants to search some speech videos related to the American presidential election. The query may explicitly or implicitly indicate whether the user expects to obtain recommended videos with high importance of visual information, and/or to obtain recommended videos with high importance of audio information. Taking the query “American presidential election speech” as an example, the keyword “speech” in the query may explicitly indicate that the user expects to obtain recommended videos with high importance of audio information. Taking a query “famous magic shows” as an example, the keyword “magic show” may explicitly indicate that the user expects to obtain recommended videos with high importance of visual information. Taking a query “sunset on the beach” as an example, the query may explicitly indicate that the user expects to obtain recommended videos with high importance of visual information.

It should be appreciated that the user input 510 is not limited to comprise any one or more of the designation of preferred importance, the designation of category, and the query as discussed above, but may comprise any other types of input from the user which can indicate expectation degree of the user for visual information and/or audio information in at least one video to be recommended.

According to the process 500, a ranking score of a candidate video may be determined based at least on a content score of the candidate video and the user input 510. In an implementation, the user input 510 of the user may be provided to a ranking model 520 as a reference factor. Moreover, a candidate video set with content scores 530 may also be provided to the ranking model 520, wherein the candidate video set with content scores 530 corresponds to the candidate video set with content scores 240 in FIG. 2. The ranking model 520 is similar with the ranking model 320, except that the reference factor in FIG. 5 is the user input 510 instead of the service configuration 310. Besides the features adopted in the existing ranking models, the ranking model 520 may further adopt a content score of a candidate video and at least one reference factor, i.e., the user input 510 in FIG. 5, as additional features. That is, the ranking model 520 may determine a ranking score of each candidate video in the candidate video set based at least on a content score of the candidate video and the user input 510. Through considering the user input 510, the ranking model 520 may acknowledge what types of candidate videos, e.g., whether visual information is important or audio information is important, are expected by the user. Through considering the content score of the candidate video, the ranking model 520 may decide whether this candidate video complies with the expectation of the user. Thus, the ranking model 520 may determine a ranking score of a candidate video in a consideration of importance of visual information and/or audio information, e.g., give a higher ranking score to a candidate video which has a content score complying with the user input 510. Through the ranking model 520, the candidate video set with respective ranking scores 540 may be obtained.

According to the process 500, after the candidate video set with respective ranking scores 540 is obtained, recommended videos 550 may be selected from the candidate video set based at least on ranking scores of candidate videos in the candidate video set. Moreover, the recommended videos 550 may be further provided to the user through the terminal device of the user.

FIG. 6 illustrates an exemplary process 600 for determining recommended videos according to an embodiment. In the process 600, reference factors for determining recommended videos may comprise service configuration of the video recommendation, a preference score of the user and a user input from the user. That is, the process 600 may be deemed as a combination of the process 300 in FIG. 3, the process 400 in FIG. 4, and the process 500 in FIG. 5.

According to the process 600, service configuration 610 of the video recommendation may be obtained, which may correspond to the service configuration 310 in FIG. 3. A preference score 620 of the user may be obtained, which may correspond to the preference score 410 in FIG. 4. A user input 630 may be obtained, which may correspond to the user input 510 in FIG. 5.

According to the process 600, a ranking score of a candidate video may be determined based at least on a content score of the candidate video, the service configuration 610, the preference score 620 and the user input 630. In an implementation, the service configuration 610, the preference score 620 and the user input 630 may be provided to a ranking model 640 as reference factors. Moreover, a candidate video set with content scores 650 may also be provided to the ranking model 640, wherein the candidate video set with content scores 650 corresponds to the candidate video set with content scores 240 in FIG. 2. Besides the features adopted in the existing ranking models, the ranking model 640 may further adopt a content score of a candidate video and at least one reference factor, i.e., the service configuration 610, the preference score 620 and the user input 630 in FIG. 6, as additional features. That is, the ranking model 520 may determine a ranking score of each candidate video in the candidate video set based at least on a content score of the candidate video and a combination of the service configuration 610, the preference score 620 and the user input 630. Through considering the combination of the service configuration 610, the preference score 620 and the user input 630, the ranking model 640 may acknowledge what types of candidate videos, e.g., whether visual information is important or audio information is important, shall be recommended to the user. Accordingly, the ranking model 640 may determine a ranking score of a candidate video in a consideration of importance of visual information and/or audio information, e.g., give a higher ranking score to a candidate video which has a content score complying with the combination of the service configuration 610, the preference score 620 and the user input 630. Through the ranking model 640, the candidate video set with respective ranking scores 660 may be obtained.

According to the process 600, after the candidate video set with respective ranking scores 660 is obtained, recommended videos 670 may be selected from the candidate video set based at least on ranking scores of candidate videos in the candidate video set. Moreover, the recommended videos 670 may be further provided to the user through the terminal device of the user.

It should be appreciated that according to actual requirements, the process 600 may be changed in various approaches. For example, any two of the service configuration 610, the preference score 620 and the user input 630 may be adopted as reference factors for the video recommendation. That is to say, the embodiments of the present disclosure may utilize at least one of service configuration, preference score and user input as reference factors to be used for further determining recommended videos.

It is discussed above in connection with FIG. 2 to FIG. 6 that some embodiments of the present disclosure may determine recommended videos from a candidate video set based at least on reference factors and content scores of candidate videos. For example, the content scores of the candidate videos in the candidate video set may be firstly determined through, e.g., a content side model, and then the content scores of the candidate videos together with the reference factors may be used for determining ranking scores of the candidate videos through, e.g., a ranking model, wherein features adopted by the ranking model at least comprise at least one reference factor and a rank score of a candidate video. However, according to some other embodiments of the present disclosure, the process of determining the content scores of the candidate videos in the candidate video may be omitted, i.e., recommended videos may be determined from the candidate video set based at least on reference factors. According to these embodiments, a ranking model may be used for determining ranking scores of the candidate videos based at least on reference factors, wherein features adopted by the ranking model at least comprise at least one reference factor and those features adopted by the content side model in FIG. 2 to FIG. 6.

FIG. 7 illustrates an exemplary process 700 for determining recommended videos according to an embodiment.

At least one of a service configuration 710 of the video recommendation, a preference score 720 of the user and a user input 730 from the user may be obtained. The service configuration 710, the preference score 720 and the user input 730 may correspond to the service configuration 310 in FIG. 3, the preference score 410 in FIG. 4 and the user input 510 in FIG. 5 respectively.

According to the process 700, a ranking score of a candidate video may be determined based at least on at least one of the service configuration 710, the preference score 720 and the user input 730.

In an implementation, at least one of the service configuration 710, the preference score 720 and the user input 730 may be provided to a ranking model 740 as reference factors. Moreover, a candidate video set 750 may also be provided to the ranking model 740, wherein the candidate video set 750 may correspond to the candidate video set 220 in FIG. 2.

The ranking model 740 may be an improved version of any existing ranking models for video recommendation. Besides features adopted in the existing ranking models, the ranking model 740 may further adopt at least one reference factor, e.g., the service configuration 710, the preference score 720 and/or the user input 730 in FIG. 7, as additional features. Moreover, the ranking model 740 may further adopt those features adopted by the content side model in FIG. 2 to FIG. 6 as additional features, comprising at least one of shot transition, camera motion, scene, human, human motion, object, object motion, text information, audio attribute, and video metadata of a candidate video. During determining a ranking score of a candidate video in the candidate video set, at least one of shot transition, camera motion, scene, human, human motion, object, object motion, text information, audio attribute, and video metadata of the candidate video may be detected. The detected information about the candidate video together with the at least one reference factor may be further used for determining the ranking score of the candidate video, e.g., through the ranking model 740. Through considering the at least one reference factor, the ranking model 740 may acknowledge what types of candidate videos, e.g., whether visual information is important or audio information is important, shall be recommended to the user. Through considering the detected information about the candidate video, the ranking model 740 may decide whether this candidate video complies with preferred importance indicated by the at least one reference factor. Accordingly, the ranking model 740 may determine a ranking score of a candidate video in a consideration of importance of visual information and/or audio information. Through the ranking model 740, the candidate video set with respective ranking scores 760 may be obtained.

According to the process 700, after the candidate video set with respective ranking scores 760 is obtained, recommended videos 770 may be selected from the candidate video set based at least on ranking scores of candidate videos in the candidate video set. Moreover, the recommended videos 770 may be further provided to the user through the terminal device of the user.

It should be appreciated that, in some implementations, the ranking models in FIG. 3 to FIG. 7 may be configured for determining a ranking score of a candidate video further based on consumption condition of the candidate video by a number of other users. The more times the candidate video is consumed by other users, the higher ranking score the candidate video may get. In some implementations, the ranking models in FIG. 3 to FIG. 7 may be configured for determining a ranking score of a candidate video further based on relevance between content of the candidate video and the user's interests. The user's interests may be determined based on, e.g., historical watching records of the user. For example, the historical watching records of the user may indicate what categories or topics of video content the user is interested in. If the content of the candidate video has a higher relevance with the user's interests, a higher ranking score may be determined for the candidate video. Moreover, in some implementations, when selecting the recommended videos from the candidate video set with ranking scores, besides considering selecting the highest ranking candidate videos based on the ranking scores, diversity of video recommendation may also be considered such that the selected recommended videos could have diversity in terms of content.

It should be appreciated that the present disclosure also covers any variants of the methods for providing video recommendation discussed above in connection with FIG. 3 to FIG. 7. For example, in an implementation, candidate videos in a candidate video set may be firstly ranked through any existing ranking models for video recommendation. Then a filtering operation may be performed on the ranked candidate videos, wherein the filtering operation may consider preferred importance of visual information and/or audio information in at least one video to be recommended. For example, at least one of the service configuration, the preference score and the user input as discussed above in FIG. 3 to FIG. 7 may be used by the filtering operation for filtering out those candidate videos not complying with the preferred importance of visual information and/or audio information in at least one video to be recommended. After the filtering operation, at least one recommended video may be obtained, and the at least one recommended video may be further provided to the user. In an implementation, the filtering operation may be implemented through a filter model which adopts features comprising at least one of service configuration, preference score and user input.

FIG. 8 illustrates a flowchart of an exemplary method 800 for providing video recommendation according to an embodiment.

At 810, at least one reference factor for the video recommendation may be determined, wherein the at least one reference factor indicates preferred importance of visual information and/or audio information in at least one video to be recommended.

At 820, a ranking score of each candidate video in a candidate video set may be determined based at least on the at least one reference factor.

At 830, at least one recommended video may be selected from the candidate video set based at least on ranking scores of candidate videos in the candidate video set.

At 840, the at least one recommended video may be provided to a user through a terminal device.

In an implementation, the at least one reference factor may comprise a preference score of the user, the preference score indicating expectation degree of the user for the visual information and/or the audio information in the at least one video to be recommended. The preference score may be determined based on at least one of: current time, current location, configuration of the terminal device, operating state of the terminal device, and historical watching behaviors of the user. The configuration of the terminal device may comprise at least one of: screen size, screen resolution, loudspeaker available or not, and peripheral earphone connected or not. The operating state of the terminal device may comprise at least one of: operating in a mute mode, operating in a non-mute mode and operating in a driving mode. The preference score may be determined through a user side model, the user side model adopting at least one of the following features: time, location, configuration of the terminal device, operating state of the terminal device, and historical watching behaviors of the user.

In an implementation, the at least one reference factor may comprise an indication of a default or current service configuration of the video recommendation. The default or current service configuration may comprise providing the at least one video to be recommended in a mute mode or in a non-mute mode.

In an implementation, the at least one reference factor may comprise a user input from the user, the user input indicating expectation degree of the user for the visual information and/or the audio information in the at least one video to be recommended. The user input may comprise at least one of: a designation of the preferred importance of the visual information and/or the audio information in the at least one video to be recommended; a designation of category of the at least one video to be recommended; and a query for searching videos.

In an implementation, the method 800 may further comprise: determining a content score of each candidate video in the candidate video set, the content score indicating importance of visual information and/or audio information in the candidate video. The determining the ranking score of each candidate video may be further based on a content score of the candidate video. The content score of each candidate video may be determined based on at least one of shot transition, camera motion, scene, human, human motion, object, object motion, text information, audio attribute, and video metadata of the candidate video. The content score of each candidate video may be determined through a content side model, the content side model adopting at least one of the following features: shot transition, camera motion, scene, human, human motion, object, object motion, text information, audio attribute, and video metadata. Alternatively, the content score of each candidate video may be determined through a content side model which is based on deep learning, the content side model being trained by a set of training data, each training data being formed by a video and a labeled content score indicating importance of visual information and/or audio information in the video. The ranking score of each candidate video may be determined through a ranking model, the ranking model at least adopting the following features: at least one reference factor; and a content score of a candidate video.

In an implementation, the method 800 may further comprise: detecting at least one of shot transition, camera motion, scene, human, human motion, object, object motion, text information, audio attribute, and video metadata of each candidate video in the candidate video set. The determining the ranking score of each candidate video may be further based on at least one of shot transition, camera motion, scene, human, human motion, object, object motion, text information, audio attribute, and video metadata of the candidate video. The ranking score of each candidate video may be determined through a ranking model, the ranking model at least adopting the following features: at least one reference factor; and at least one of shot transition, camera motion, scene, human, human motion, object, object motion, text information, audio attribute, and video metadata of a candidate video.

In an implementation, the determining the ranking score of each candidate video may be further based on at least one of: consumption condition of the candidate video by a number of other users; and relevance between content of the candidate video and the user's interests.

In an implementation, the video recommendation may be provided in a client application or service providing website.

It should be appreciated that the method 800 may further comprise any steps/processes for providing video recommendation according to the embodiments of the present disclosure as mentioned above.

FIG. 9 illustrates an exemplary apparatus 900 for providing video recommendation according to an embodiment.

The apparatus 900 may comprise: a reference factor determining module 910, for determining at least one reference factor for the video recommendation, the at least one reference factor indicating preferred importance of visual information and/or audio information in at least one video to be recommended; a ranking score determining module 920, for determining a ranking score of each candidate video in a candidate video set based at least on the at least one reference factor; a recommended video selecting module 930, for selecting at least one recommended video from the candidate video set based at least on ranking scores of candidate videos in the candidate video set; and a recommended video providing module 940, for providing the at least one recommended video to a user through a terminal device.

In an implementation, the at least one reference factor may comprise at least one of: a preference score of the user; an indication of a default or current service configuration of the video recommendation; and a user input from the user.

Moreover, the apparatus 900 may also comprise any other modules configured for providing video recommendation according to the embodiments of the present disclosure as mentioned above.

FIG. 10 illustrates an exemplary apparatus 1000 for providing video recommendation according to an embodiment.

The apparatus 1000 may comprise at least one processor 1010 and a memory 1020 storing computer-executable instructions. When executing the computer-executable instructions, the at least one processor 1010 may: determine at least one reference factor for the video recommendation, the at least one reference factor indicating preferred importance of visual information and/or audio information in at least one video to be recommended; determine a ranking score of each candidate video in a candidate video set based at least on the at least one reference factor; select at least one recommended video from the candidate video set based at least on ranking scores of candidate videos in the candidate video set; and provide the at least one recommended video to a user through a terminal device.

The at least one processor 1010 may be further configured for performing any operations of the methods for providing video recommendation according to the embodiments of the present disclosure as mentioned above.

Methods and apparatuses for providing video recommendation have been discussed above based on various embodiments of the present disclosure. It should be appreciated that any additions, deletions, replacements, reconstructions, and derivations of components included in these methods and apparatuses shall also be covered by the present disclosure.

According to an exemplary embodiment, a method for presenting recommended videos to a user is provided.

During the user is accessing a third party application or website which provides video recommendation service, a user input may be received. The received user input may correspond to, e.g., the user input 510 in FIG. 5, the user input 630 in FIG. 6, the user input 730 in FIG. 7, etc. In an implementation, the operation of receiving the user input may comprise receiving, from the user, a designation of preferred importance of visual information and/or audio information in at least one video to be recommended. For example, when the user selects one of options of preferred importance provided in a user interface of the third party application or website, a designation of the preferred importance may be received. In an implementation, the operation of receiving the user input may comprise receiving, from the user, a designation of category of at least one video to be recommended. For example, when the user selects or inputs, in the user interface of the third party application or website, at least one desired category of at least one video to be recommended, a designation of the category may be received. In an implementation, the operation of receiving the user input may comprise receiving, from the user, a query for searching videos. For example, when the user inputs a query in the user interface of the third party application or website so as to search videos that the user is interested, the query may be received.

According to the method, the received user input may be used for identifying preferred importance of visual information and/or audio information in at least one video to be recommended, e.g., expectation degree of the user for visual information and/or audio information in at least one video to be recommended. For example, if a category “talk show” is designated in the user input, it may be identified that the user expects to obtain recommended videos with high importance of audio information. For example, if a query “famous magic shows” is included in the user input, it may be identified that the user expects to obtain recommended videos with high importance of visual information.

According to the method, the identified preferred importance may be further used for determining at least one recommended video from a candidate video set. For example, those ranking approaches discussed above in FIG. 3 to FIG. 7 may be adopted here for ranking candidate videos in the candidate video set and further selecting the at least one recommended video from the ranked candidate videos.

According to the method, the determined at least one recommended video may be presented to the user through the user interface. In an implementation, a recommended video list may be formed and presented to the user. In an implementation, if there is a recommended video list already presented to the user, the determined at least one recommended video may be used for updating the recommended video list.

An apparatus for presenting recommended videos to a user may be provided, which comprises various modules configured for performing any operations of the above method may be provided. Moreover, an apparatus for presenting recommended videos to a user may be provided, which comprises at least one processor and a memory storing computer-executable instructions, wherein the at least one processor may be configured for performing any operations of the above method.

According to another exemplary embodiment, a method for presenting recommended videos to a user is provided.

During the user is accessing a third party application or website which provides video recommendation service, a service configuration of video recommendation may be detected. The detected service configuration may correspond to, e.g., the service configuration 310 in FIG. 3.

According to the method, the detected service configuration may be used for identifying preferred importance of visual information and/or audio information in at least one video to be recommended. For example, if the service configuration indicates that recommended videos shall be provided in a mute mode, it may be identified that those videos with high importance of visual information are preferred to be recommended.

According to the method, the identified preferred importance may be further used for determining at least one recommended video from a candidate video set. For example, those ranking approaches discussed above in FIG. 3 to FIG. 7 may be adopted here for ranking candidate videos in the candidate video set and further selecting the at least one recommended video from the ranked candidate videos.

According to the method, the determined at least one recommended video may be presented to the user through the user interface. In an implementation, a recommended video list may be formed and presented to the user. In an implementation, if there is a recommended video list already presented to the user, the determined at least one recommended video may be used for updating the recommended video list.

An apparatus for presenting recommended videos to a user may be provided, which comprises various modules configured for performing any operations of the above method may be provided. Moreover, an apparatus for presenting recommended videos to a user may be provided, which comprises at least one processor and a memory storing computer-executable instructions, wherein the at least one processor may be configured for performing any operations of the above method.

According to another exemplary embodiment, a method for presenting recommended videos to a user is provided.

During the user is accessing a third party application or website which provides video recommendation service, a preference score of the user may be determined. The preference score may correspond to, e.g., the preference score 410 in FIG. 4, and may be determined in a similar way as that discussed in FIG. 4.

According to the method, the determined preference score may be used for identifying preferred importance of visual information and/or audio information in at least one video to be recommended, e.g., expectation degree of the user for visual information and/or audio information in a video to be recommended. For example, the preference score may indicate whether the user expects to obtain recommended videos with high importance of visual information or expects to obtain recommended videos with high importance of audio information.

According to the method, the identified preferred importance may be further used for determining at least one recommended video from a candidate video set. For example, those ranking approaches discussed above in FIG. 3 to FIG. 7 may be adopted here for ranking candidate videos in the candidate video set and further selecting the at least one recommended video from the ranked candidate videos.

According to the method, the determined at least one recommended video may be presented to the user through the user interface. In an implementation, a recommended video list may be formed and presented to the user. In an implementation, if there is a recommended video list already presented to the user, the determined at least one recommended video may be used for updating the recommended video list.

An apparatus for presenting recommended videos to a user may be provided, which comprises various modules configured for performing any operations of the above method may be provided. Moreover, an apparatus for presenting recommended videos to a user may be provided, which comprises at least one processor and a memory storing computer-executable instructions, wherein the at least one processor may be configured for performing any operations of the above method.

The embodiments of the present disclosure may be embodied in a non-transitory computer-readable medium. The non-transitory computer-readable medium may comprise instructions that, when executed, cause one or more processors to perform any operations of the methods for providing video recommendation or for presenting recommended videos according to the embodiments of the present disclosure as mentioned above.

It should be appreciated that all the operations in the methods described above are merely exemplary, and the present disclosure is not limited to any operations in the methods or sequence orders of these operations, and should cover all other equivalents under the same or similar concepts.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout the present disclosure. The functionality of a processor, any portion of a processor, or any combination of processors presented in the present disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors, e.g., cache or register.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are expressly incorporated herein by reference and are intended to be encompassed by the claims.

What is claimed is:

1. A method for providing video recommendation, comprising:
determining at least one reference factor for the video recommendation, the at least one reference factor indicating preferred importance of visual information and/or audio information in at least one video to be recommended;
determining a ranking score of each candidate video in a candidate video set based at least on the at least one reference factor;
selecting at least one recommended video from the candidate video set based at least on ranking scores of candidate videos in the candidate video set; and
providing the at least one recommended video to a user through a terminal device.

2. The method of claim 1, wherein the at least one reference factor comprises a preference score of the user, the preference score indicating expectation degree of the user for the visual information and/or the audio information in the at least one video to be recommended.

3. The method of claim 2, wherein the preference score is determined based on at least one of: current time, current location, configuration of the terminal device, operating state of the terminal device, and historical watching behaviors of the user.

4. The method of claim 3, wherein
the configuration of the terminal device comprises at least one of: screen size, screen resolution, loudspeaker available or not, and peripheral earphone connected or not, and
the operating state of the terminal device comprises at least one of: operating in a mute mode, operating in a non-mute mode and operating in a driving mode.

5. The method of claim 3, wherein the preference score is determined through a user side model, the user side model adopting at least one of the following features: time, location, configuration of the terminal device, operating state of the terminal device, and historical watching behaviors of the user.

6. The method of claim 1, wherein the at least one reference factor comprises an indication of a default or current service configuration of the video recommendation.

7. The method of claim 6, wherein the default or current service configuration comprises providing the at least one video to be recommended in a mute mode or in a non-mute mode.

8. The method of claim 1, wherein the at least one reference factor comprises a user input from the user, the user input indicating expectation degree of the user for the visual information and/or the audio information in the at least one video to be recommended.

9. The method of claim 8, wherein the user input comprises at least one of:
a designation of the preferred importance of the visual information and/or the audio information in the at least one video to be recommended;
a designation of category of the at least one video to be recommended; and
a query for searching videos.

10. The method of claim 1, further comprising:
determining a content score of each candidate video in the candidate video set, the content score indicating importance of visual information and/or audio information in the candidate video, and
wherein the determining the ranking score of each candidate video is further based on a content score of the candidate video.

11. The method of claim 10, wherein the content score of each candidate video is determined based on at least one of shot transition, camera motion, scene, human, human motion, object, object motion, text information, audio attribute, and video metadata of the candidate video.

12. The method of claim 10, wherein the content score of each candidate video is determined through a content side model, the content side model adopting at least one of the following features: shot transition, camera motion, scene, human, human motion, object, object motion, text information, audio attribute, and video metadata.

13. The method of claim 10, wherein the content score of each candidate video is determined through a content side model which is based on deep learning, the content side model being trained by a set of training data, each training data being formed by a video and a labeled content score indicating importance of visual information and/or audio information in the video.

14. The method of claim 10, wherein the ranking score of each candidate video is determined through a ranking model, the ranking model at least adopting the following features: at least one reference factor; and a content score of a candidate video.

15. The method of claim 1, further comprising:
detecting at least one of shot transition, camera motion, scene, human, human motion, object, object motion, text information, audio attribute, and video metadata of each candidate video in the candidate video set, and
wherein the determining the ranking score of each candidate video is further based on at least one of shot transition, camera motion, scene, human, human motion, object, object motion, text information, audio attribute, and video metadata of the candidate video.

16. The method of claim 15, wherein the ranking score of each candidate video is determined through a ranking model, the ranking model at least adopting the following features: at least one reference factor; and at least one of shot transition, camera motion, scene, human, human motion, object, object motion, text information, audio attribute, and video metadata of a candidate video.

17. The method of claim 1, wherein the determining the ranking score of each candidate video is further based on at least one of: consumption condition of the candidate video by a number of other users; and relevance between content of the candidate video and the user's interests.

18. The method of claim 1, wherein the video recommendation is provided in a client application or service providing website.

19. An apparatus for providing video recommendation, comprising:
a reference factor determining module, for determining at least one reference factor for the video recommendation, the at least one reference factor indicating preferred importance of visual information and/or audio information in at least one video to be recommended;
a ranking score determining module, for determining a ranking score of each candidate video in a candidate video set based at least on the at least one reference factor;
a recommended video selecting module, for selecting at least one recommended video from the candidate video set based at least on ranking scores of candidate videos in the candidate video set; and
a recommended video providing module, for providing the at least one recommended video to a user through a terminal device.

20. An apparatus for providing video recommendation, comprising:
one or more processors; and
a memory storing computer-executable instructions that, when executed, cause the one or more processors to:
determine at least one reference factor for the video recommendation, the at least one reference factor indicating preferred importance of visual information and/or audio information in at least one video to be recommended;
determine a ranking score of each candidate video in a candidate video set based at least on the at least one reference factor;
select at least one recommended video from the candidate video set based at least on ranking scores of candidate videos in the candidate video set; and
provide the at least one recommended video to a user through a terminal device.
